(19) United States
(12) Patent Application Publication
(10) Pub. No.: US 2012/0148988 A1
(43) Pub. Date: Jun. 14, 2012

(54) Indirect restoration technology

(75) Inventors: Rodolfo Castillo, Boca Raton, FL (US); Robin A. Carden, San Juan Capistrano, CA (US); Wolfgang Friebauer, Costa Mesa, CA (US)

(73) Assignee: James R. Glidewell Dental Ceramics, Inc.

(21) Appl. No.: 13/374,041

(22) Filed: Dec. 8, 2011

Related U.S. Application Data
(60) Provisional application No. 61/459,506, filed on Dec. 14, 2010.

(51) Int. Cl. A61C 5/09; C03B 11/00; C03C 27/02

(52) U.S. Cl. 433/222.1; 65/59.1

(57) ABSTRACT

Dental restorations such as crowns, are made from lithium silicate glass ceramic that is heated and pressed onto a metal substrate, the latter being shaped to an impression or scan of the area of the mouth to receive the restoration. The metal substrate is made from an alloy selected to exhibit a coefficient of thermal expansion which is slightly greater than the CTE of the lithium silicate. In a preferred embodiment, the CTE of the lithium silicate glass ceramic is in the range of 11.5 to 12.5 and the alloy is selected to have a CTE of 12 to 13.5. A palladium tin alloy provides that CTE in the preferred embodiment.

### CROSS-REFERENCE TO RELATED APPLICATIONS

This application takes priority from provisional application Ser. No. 61/459,506, filed on Dec. 14, 2010.

### BACKGROUND OF THE INVENTION

1. Field of the Invention

The present invention relates generally to dental restorations. The invention herein relates more specifically to improved indirect dental restorations such as crowns wherein instead of employing porcelain fused to metal, the restoration employs a much stronger lithium silicate glass material pressed onto a metal alloy especially selected for its compatible thermal expansion properties.

2. Background Discussion

A dental restoration or dental filling is a dental restorative material used to restore the function, integrity and morphology of missing tooth structure. The structural loss typically results from caries or external trauma. It is also sometimes lost intentionally during tooth preparation to improve the aesthetics or the physical integrity of the intended restorative material. Dental restoration also refers to the replacement of missing tooth structure that is supported by dental implants.

Dental restorations can be divided into two broad types: direct restorations and indirect restorations. Direct restorations are done on the spot such as filling a tooth that has a cavity. Indirect restorations require a subsequent visit after initial measurements are taken. All dental restorations can be further classified by their location and size. A root canal filling is a restorative technique used to fill the space where the dental pulp normally resides.

The present invention concentrates on indirect restoration technology. The inventive technique relates to fabricating the restoration outside of the mouth using the dental impressions of the prepared tooth. Common indirect restorations include inlays and onlays, crowns, bridges, and veneers. Usually a dental technician fabricates the indirect restoration from records of the prepared tooth the dentist has provided. The finished restoration is usually bonded permanently with a dental cement. It is often done in two separate visits to the dentist. Common indirect restorations are done using gold or ceramics.

While the indirect restoration is being prepared, a provisory/temporary restoration is sometimes used to cover the prepared part of the tooth, and thereby help maintain the surrounding dental tissues.

When an individual needs a tooth restoration, a cosmetic dentist/technician may recommend that they receive a porcelain-fused-to-metal crown (also known as a PFM crown). A porcelain-fused-to-metal crown is constructed out of a metal core that is surrounded by a layer of baked porcelain fused to the metal.

Any number of reasons exist why a dentist may recommend a PFM crown. One reason is that the dentist may need to repair a previously filled tooth that has lost its dental filling. This tooth will require repair, and a crown is an excellent way to save the tooth, protect it from future decay, and restore its full functionality.

A tooth can also be damaged by grinding and clenching. A PFM crown is an excellent way of restoring its damaged and worn surface areas. But because of differences in the coefficient of thermal expansion (CTE), problems exist in using different materials, and as a result porcelain cracks and reveals the base alloy. By using a lithium silicate glass, one can obtain a 3× factor in MPa strength over porcelain and thereby provide a restoration that is likely to last many years longer than a typical PFM.

A tooth can be severely damaged by severe cracks and fractures. Many times these breaks are so severe that some dentists would assume the tooth is unsalvageable and recommend a tooth extraction. Instead, a porcelain-fused-to-metal crown can be placed over even a severely broken tooth and be made to function as if it were new.

Getting fitted with a porcelain-fused-to-metal crown always takes a patient more than one trip to the dentist because it involves a number of preparatory steps and the assistance of a special dental laboratory dedicated to the custom manufacture of various cosmetic dental restorations, including dental crowns. Most of the time, if all goes as planned; a patient will be fitted with a crown in two appointments.

The first appointment focuses on preparation. The dentist begins by numbing the area that surrounds the tooth. The dentist also places a rubber dam in the back of the mouth to protect the throat from dental debris. Next, he or she uses a dental hand-piece to remove any decay away from the tooth and shapes it at the same time into a surface that will effectively wear the crown.

Once this process is completed, an impression of the teeth is made. Using this impression, the dentist will make a model of the teeth. This model is then sent to the dental lab. Before sending the patient home, the dentist completes the first visit by fitting the patient with a temporary crown that will protect the tooth during the interim between office visits.

Once the permanent crown is completed by the dental laboratory and sent to the dentist's office, the patient returns for a second visit. During this second visit, the temporary crown is removed, the prepped tooth is treated with an antiseptic and the new crown is cemented onto the prepped tooth, usually using a UV curable cement.

### SUMMARY OF THE INVENTION

The present invention comprises restorations wherein lithium silicate is employed as a substitute for porcelain, heated and pressed onto a metal alloy substrate.

Patients can expect several benefits from a lithium silicate crown. For one thing, it will better cover and protect the tooth as compared to a typical PFM. This is the most important benefit gained from any type of dental crown, be it gold, porcelain, or PFM. Additional benefits to be expected are as follows:
1. Aesthetics, more tooth color like with translucency.
2. Strength: High flexural strength of MPa of 300 MPa compared to porcelain at 70-125 MPa.
3. Very stable CTE over multiple firings.
4. Pressing will be easier than multiple layers of porcelain.

The lithium silicate is made in an oval block form which is inserted, heated and then pressed over an alloy, which is made from a base impression. The preferred alloy will have a coefficient of thermal expansion (CTE) which is slightly greater than that of the lithium silicate material. The latter has a CTE in the range of 11.5 to 12.5. Therefore, a metal alloy having a CTE in the 12 to 13.5 range is desired. The reason for this choice of respective GTE's is to permit the metal alloy to expand slightly more than the overlying lithium silicate so that there is a reduced likelihood of separation which could impact the integrity of the restoration. If the metal alloy expands less than the lithium silicate material, there is a high probability of separation during heating such as during fabrication of the restoration.

In the preferred embodiment, the metal alloy is a palladium/tin alloy wherein the ratio of respective metals is selected to provide a CTE in the range of 12 to 13.5.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIGS. 1A and 1B are cross-sectional views of respective dental crowns comprising the combination of materials of the invention hereof;

FIG. 2 is a cross-sectional view of a more complex dental restoration consisting of a bridge formed by the materials of the invention; and

FIG. 3 is a graph showing the percentage linear change vs. temperature for the lithium silicate glass ceramic and the Pd-Sn alloy of a preferred embodiment.

### DETAILED DESCRIPTION OF A PREFERRED EMBODIMENT OF THE INVENTION

The present invention may be best understood by referring to the accompanying drawings which show a preferred embodiment of the restorations made with lithium silicate on a metal alloy substrate. The lithium silicate, when pressed onto a metal alloy substrate, may be deemed to be a substitute material for porcelain fused to metal. One significant advantage derived from the use of lithium silicate instead of porcelain is the strength of the material. Lithium silicate has a strength in MPa which is approximately three times that of dental porcelain. The flexural strength of porcelain is in the range of 70 to 125 MPa. The flexural strength of lithium silicate glass ceramic is in the range of 300 to 380 MPa.

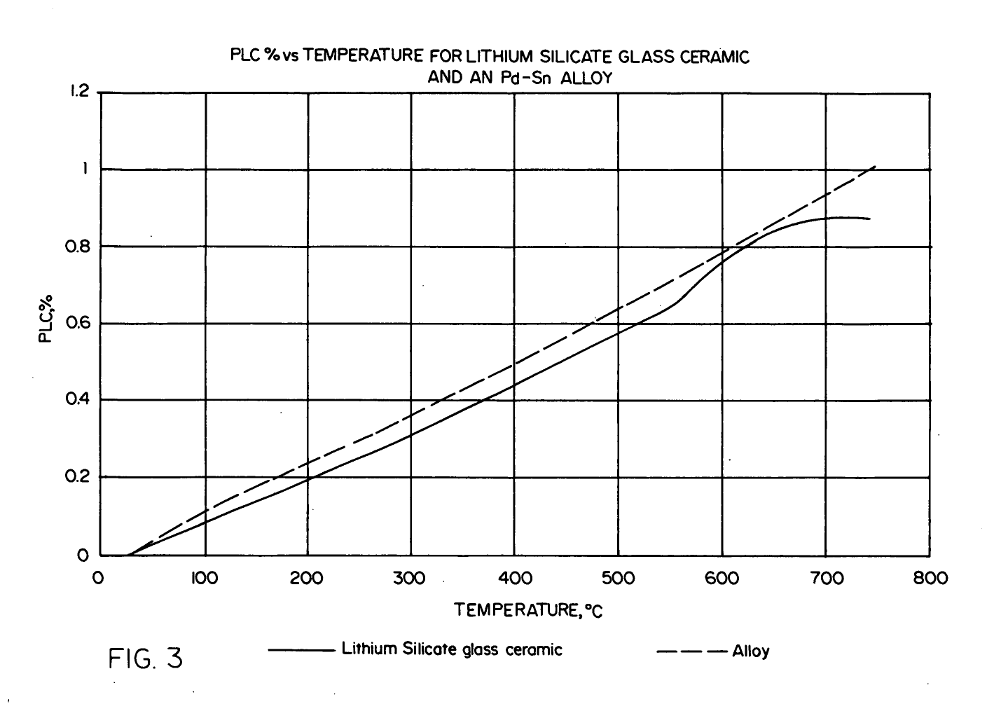

In one preferred embodiment, the lithium silicate is heated and pressed onto a metal alloy substrate made primarily of palladium and tin. This alloy has a coefficient of thermal expansion in the desired range of 12 to 13.5. This CTE is slightly higher than the CTE of the lithium silicate which is about 11.5 to 12.5. Having the CTE of the metal alloy substrate slightly higher than the CTE of the lithium silicate, permits the restoration to undergo increases in temperature with relatively little risk of separation because of over expansion of the lithium silicate glass relative to the metal substrate. There may be other suitable metal alloy formulations which would be compatible with the lithium silicate CTE of 11.5 to 12.5, and which would thus have a CTE preferably in the range of 12 to 13.5. FIG. 3 shows graphically the relative percentage linear change versus temperature for the selected palladium tin alloy and the lithium silicate glass ceramic in the preferred embodiment.

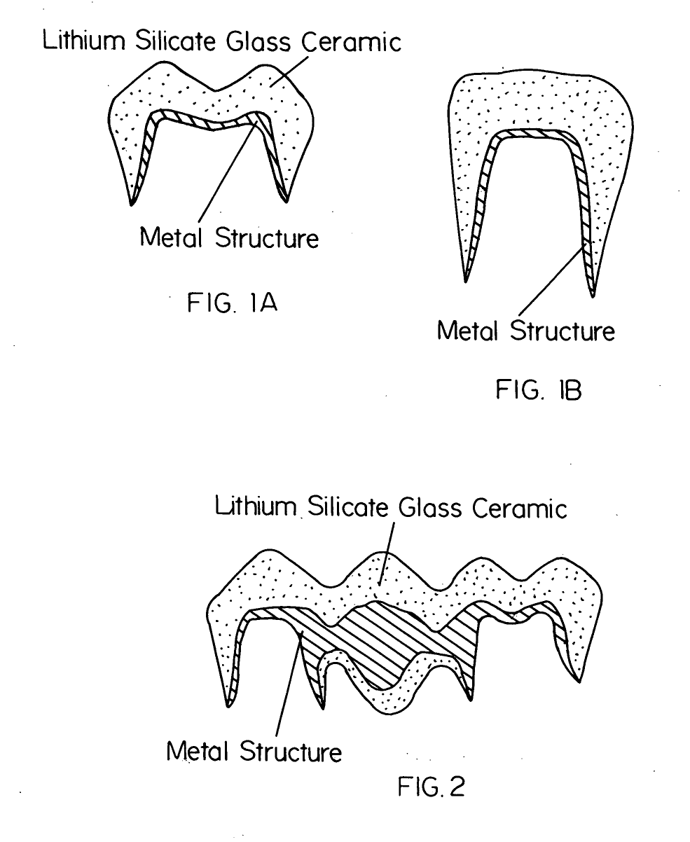

The preferred fabrication process comprises the steps of forming a block of the lithium silicate glass of selected color and texture and preparing the metal alloy substrate for geometric compatibility with an impression or digital scan of the tooth or teeth to be replaced or covered. Then the glass is inserted, heated and pressed over the alloy substrate to form the restoration such as depicted by way of example in FIGS. 1A, 1B and 2. The resulting restoration will have a more accurate tooth color and superior strength as compared to typical PFM restorations. Moreover, it will be more stable at elevated temperatures and easier to press onto the substrate, thus reducing the complexity of fabrication.

Thus it will be understood that the present invention comprises an indirect dental restoration formed of lithium silicate translucent glass ceramic heated and pressed onto a metal alloy substrate. In the preferred embodiment, the metal alloy has a slightly higher coefficient of thermal expansion than the lithium silicate glass ceramic. In one such preferred embodiment, the metal alloy substrate is formed from a palladium tin alloy wherein the relative constituents are selected to provide a CTE of 12 to 13.5 as compared to the lithium silicate CTE of 11.5 to 12.5.

We claim:

1. A dental restoration comprising:
a lithium silicate translucent glass heated and pressed onto a metal alloy substrate, the latter being shaped to conform to a base impression or scan of the relevant portion of the mouth, the lithium silicate being shaped to replicate the dental structure being restored;
the coefficient of thermal expansion of the metal alloy being selected to be slightly greater than the CTE of the lithium silicate glass ceramic.

2. The dental restoration recited in claim 1 wherein the metal alloy is selected to have a CTE in the range of 12 to 13.5.

3. The dental restoration of claim 2 wherein said metal alloy comprises palladium and tin.

4. The dental restoration recited in claim 1 wherein the lithium silicate translucent glass has a CTE in the range of 11.5 to 12.5.

5. The dental restoration recited in claim 2 wherein the lithium silicate translucent glass has a CTE in the range of 11.5 to 12.5.

6. A process of fabricating a dental restoration; the method comprising the steps of:
a) forming a block of lithium silicate glass of selected color and texture;
b) preparing a metal alloy substrate having geometric compatibility with a tooth to be restored;
c) inserting the glass blank into the substrate;
d) heating the glass; and
e) pressing the heated glass into a shape replicating the surface of the tooth.

7. The process recited in claim 6 wherein step a) comprises the additional step of selecting a lithium silicate glass having a coefficient of thermal expansion which is less than the coefficient of thermal expansion of said metal alloy substrate.

8. The process recited in claim 6 wherein step a) comprises the additional step of selecting a lithium silicate glass having a coefficient of thermal expansion which is in the range of 11.5 to 12.5.

9. The process recited in claim 6 wherein step b) comprises the additional step of selecting a metal alloy substrate having palladium and tin.

10. The process recited in claim 6 wherein step b) comprises the additional step of selecting a metal alloy substrate having a coefficient of thermal expansion in the range of 12 to 13.5.
